(19) United States
(12) Patent Application Publication
(10) Pub. No.: US 2002/0097471 A1
(43) Pub. Date: Jul. 25, 2002

(54) Data transmission via direct modulation of a mid-IR laser

(76) Inventors: Clyde George Bethea, Franklin Park, NJ (US); Federico Capasso, Westfield, NJ (US); Alfred Yi Cho, Summit, NJ (US); Claire F. Gmachi, New Providence, NJ (US); Albert Lee Hutchinson, Columbus, GA (US); Rainer Martini, Hoboken, NJ (US); Roberto Paiella, Short Hills, NJ (US); Deborah Lee Sivco, Warren, NJ (US); Alessandro Tredicucci, Chiavari (IT); Edward Anthony Whittaker, Hoboken, NJ (US)

Correspondence Address: Lucent Technologies Inc., Docket Administrator (Room 3J-219), 101 Crawfords Corner Road, Holmdel, NJ, 07733, US

(21) Appl. No.: 09/896,783

(22) Filed: Jun. 29, 2001

Related U.S. Application Data
(60) Provisional application No. 60/263,256, filed on Jan. 22, 2001.

(51) Int. Cl. H04B 10/00; H04B 10/04

(52) U.S. Cl. 359/172; 359/180

(57) ABSTRACT

A process for optically transmitting data to a remote receiver includes receiving a stream of input data signals and modulating a mid-IR laser by direct modulation with a waveform whose sequential values are responsive of the data signals of the stream. The direct modulation includes pumping the mid-IR laser to produce high and low optical power levels in response to different ones of the values. The process also includes transmitting output light from the modulated mid-IR laser to the remote receiver via a free space communications channel.

This application claims the benefit of U.S. Provisional Application No. 60/263,256, filed on Jan. 22, 2001.

The U.S. Government has certain rights as provided by the terms of contract Nos. DAAD19-00-C-0096 awarded by DARPA and the US Army Research Office and by the terms of contract No. DE-FG08-99NV13656 awarded by the US Department of Energy.

### BACKGROUND OF THE INVENTION

1. Field of the Invention

This invention relates to laser modulation and optical data transmission.

2. Discussion of the Related Art

Recently, increased interest in free-space optical data transmission (FSODT) has emerged, because FSODT is economically attractive in dense urban areas. In such areas, using FSODT enables one to avoid installing new electrical cables or optical fibers. Installing cables and fibers is prohibitively costly in urban areas. Instead of cables and optical fibers, FSODT uses free space to carry communications, e.g., the air space between building rooftops. Such free space transmission is however, susceptible to interference from atmospheric conditions such as fog, pollution, and precipitation.

Conventional FSODT systems have used near-IR lasers with wavelengths of around 1.55 microns to optically transmit data through free space. The near-IR lasers of the conventional FSODT transmitters have continuous wave outputs that are modulated to introduce data prior to free-space transmission to a distant receiver.

These conventional FSODT systems have several limitations. First, the systems are based on near-IR lasers, which have to be operated at a limited power level to retain eye-safety. Second, the near-IR lasers produce light with wavelengths for which atmospheric attenuation (i.e., absorption and scattering) can be high enough to impede transmission. For example, transmitted wavelengths are often strongly absorbed during bad weather conditions, e.g., fog. Third, conventional FSODT systems use complex transmitters that include a laser and a modulator at the output of the laser. These complex transmitters are difficult to manufacture as monolithic devices, and thus, the manufacture of such monolithic devices is subject to low yields.

### BRIEF SUMMARY OF THE INVENTION

In one aspect, the invention features a process for optically transmitting data to a remote receiver. The process includes receiving a stream of input data signals and modulating a mid-IR laser by direct modulation with a waveform whose sequential values are responsive of the data signals of the stream. Mid-infrared (mid-IR) lasers lase at wavelengths in the range of about 3.5 microns to about 20 microns. The direct modulation includes pumping the mid-IR laser to produce high and low optical power levels in response to different ones of the values. The process also includes transmitting output light from the modulated mid-IR laser to the remote receiver via a free space communications channel. The transmitted light associated with the high and the low optical power levels are identifiable as “signal-on” and “signal-off”, respectively, by the remote receiver.

In another aspect, the invention features an optical transmitter. The optical transmitter includes a mid-IR laser with an optical gain media and an electrical modulator that is connected to modulate pumping of the gain media during modulation intervals. The modulator modulates the pumping in a manner responsive to values of data signals received in associated data intervals. The modulator is configured to cause the mid-IR laser to produce one optical power level in portions of modulation intervals associated with one value of the data signals and to produce relatively lower optical power levels in remainders of the modulation intervals associated with the one value of the data signal.

### BRIEF DESCRIPTION OF THE DRAWINGS

FIG. 1A illustrates transient drift in output power of a quantum cascade (QC) laser after turning the laser on;

FIG. 1B shows how the output power of the same QC laser responds to being pumped by an alternating voltage;

FIG. 1C shows how the output power of the same QC laser responds to being pumped by a higher frequency (HF) alternating voltage;

FIG. 2 shows how the output power of the same QC laser reacts to being pumped by a voltage whose amplitude represents a pseudo-random bit sequence;

FIG. 3A shows a mid-IR optical transmitter that uses direct modulation of a mid-IR laser;

FIG. 3B shows a modulation waveform produced by one embodiment of a modulator for the transmitter of FIG. 3A;

FIG. 4 shows one embodiment of a free-space communication system based on the transmitter of FIG. 3A;

FIG. 5 is a flow chart illustrating a process that transmits data by direct modulation of a QC laser; and

FIG. 6 shows received signal and noise levels for free-space data transmission based on the communication system of FIG. 4.

### DETAILED DESCRIPTION OF THE EMBODIMENTS

Quantum cascade (QC) lasers have properties that are advantageous for free-space optical transmitters. For example, QC lasers are mid-IR lasers with high output powers. Herein, mid-infrared (mid-IR) lasers lase at wavelengths in the range of about 3.5 microns to about 20 microns.

Various embodiments use QC lasers that lase at wavelengths in windows where atmospheric absorption is low. One low absorption window includes wavelengths in the range from about 8 microns to about 13 microns. Another low absorption window includes wavelengths in the range from about 3.5 microns to about 5 microns where these wavelengths are not in the CO₂ absorption peak located at about 4.65 microns.

QC lasers can also be directly modulated at high frequencies. Herein, direct modulation refers to modulation that changes pumping of a laser between a value for which the laser has a high output power level and a value for which the laser has a low output power level. At these high and low power levels, a remote optical receiver would identify the laser as being in signal-on and signal-off states, respectively. In some embodiments, the high and low power levels correspond to respective lasing and non-lasing states of the laser. Such on/off direct modulation may be produced by pumping the gain medium of the laser with a pumping current or light intensity that takes values both below and above a threshold for sustained stimulated emission. In other embodiments, the high and low power levels correspond to states that a remote receiver would identify as apparently laser-on and laser-off states. The laser-off state results when the medium between the laser and receiver produces enough fixed attenuation so that the received optical power level is below the threshold of the receiver. In such embodiments, the output laser power is simply turned down in the low power state so that the laser appears to be off to the remote receiver.

QC lasers may be modulated by direct modulation. But, QC lasers produce more heat than conventional mid-IR and near-IR lasers. The increased heat production makes direct modulation more likely to cause a QC laser to suffer from temperature-induced drift.

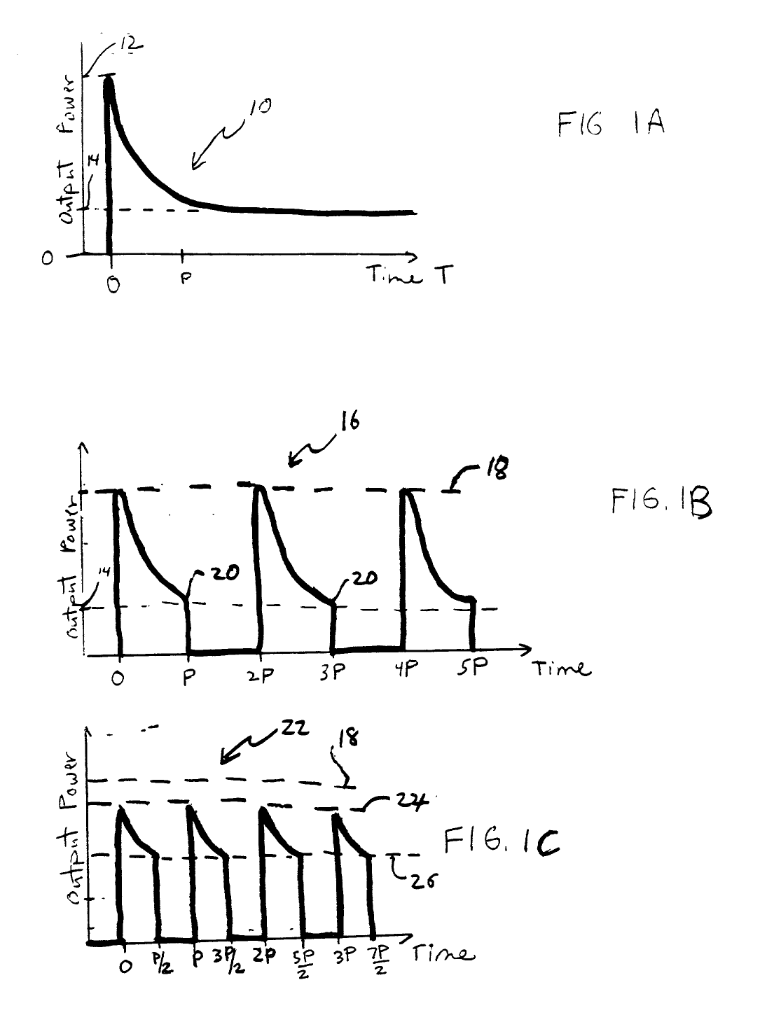

FIG. 1A is a graph 10 showing optical output power of a QC laser from first application of an above-lasing-threshold voltage across the laser's gain medium. At time T=0, the pump voltage abruptly changes from one constant value, e.g., below the lasing-threshold to another constant above the lasing-threshold. In response, the laser's optical output power jumps to a maximum value 12, at T=0, and decays during a transient period of length P to a lower steady state value 14.

In FIG. 1A, the transient behavior of the laser's output power results from a change in the inverted carrier population. The inverted population, which determines the amount of light produced by stimulated emission, has a maximum value just after the laser starts lasing at time T=0 and a lower value at large values of the time T. The inverted carrier population changes, because prolonged lasing heats the laser's gain medium thereby changing the population.

FIG. 1B is a graph 16 of optical output power from the same QC laser of FIG. 1A when modulated by direct modulation with a square wave pumping voltage of period P. The maximum and minimum voltages of the square wave are respectively, above and below the threshold voltage for lasing. Though the laser pumping voltage is a square wave, the laser's output power does not have the form of a square wave due to heating of the laser's gain media.

Furthermore, the maximum optical output power 18 of FIG. 1B is lower than the maximum optical output power 12 of FIG. 1A, because the modulation frequency is too high for the laser to cool down between lasing periods. For the same reason, the difference between the maximum and minimum optical output powers 18, 20 during lasing periods is smaller when square wave modulated as shown in FIG. 1B than when pumped by a constant pumping voltage as shown in FIG. 1A. Modulation of a QC laser with an alternating pumping voltage affects heating of the laser's gain media and thus, affects the laser's optical output power.

FIG. 1C is a graph 22 of the optical output power of the same QC laser when modulated by direct modulation with a square wave that has the same amplitude as in FIG. 1B and a shorter period, P/2. The shorter modulation period lowers the maximum value of the optical output power 24 during lasing. Similarly, the differences between the maximum and minimum values of the optical output power 24, 26 during lasing periods are also smaller in response to the shorter modulation period. The trend of the maximum optical output power to decrease as the modulation frequency increases is related to the shortening of the time available to cool the laser's gain media between lasing periods as the modulation rate increases.

FIGS. 1A-1C show how the optical output power of a QC laser changes with modulation rate for high modulation rates. The optical output power also changes with the form of the modulation data sequence.

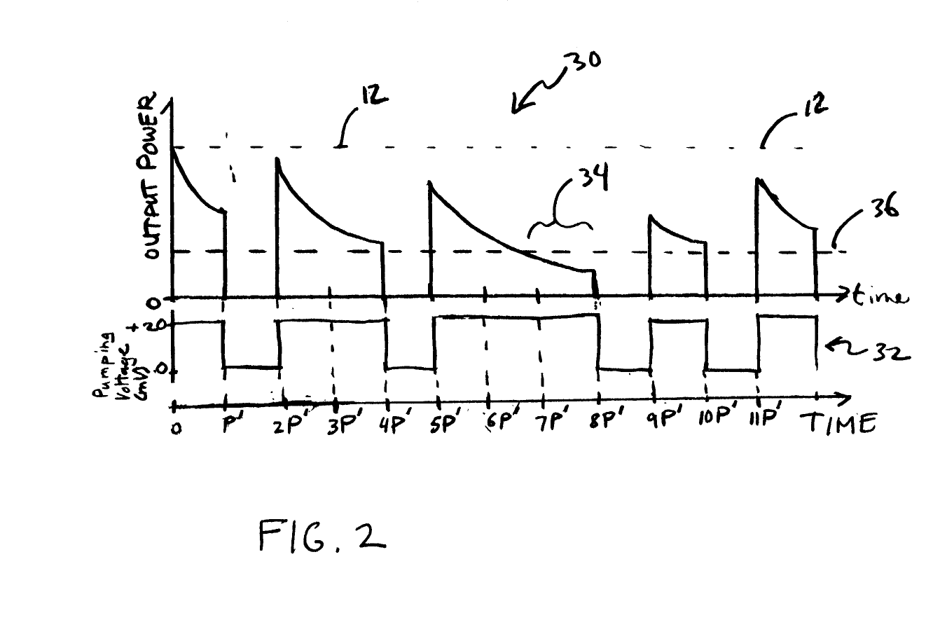

FIG. 2 is a graph 30 of the optical output power of the same QC laser when modulated with a random binary sequence of pumping voltages 32 during intervals of length P′. For each interval of the sequence, the modulated part of the pumping voltage is e.g., 20 millivolts (mV) or 0 mV. During different lasing intervals of the sequence, the optical output power of the laser differs due to differences in the temperature of the laser's gain media. During a particular modulation interval, the temperature of the gain medium depends on the value of the modulation voltage during earlier intervals. The gain medium is hotter for lasing intervals preceded by a sequence of other lasing intervals, because previously produced heat has not dissipated in such a case. A hotter gain medium produces lower optical output power for the same pumping voltage. For example, interval 34 is preceded by two lasing intervals and is thus, an interval in which the gain media is hotter. The optical output power is also lower in the hotter interval 34 than in the two preceding intervals.

FIG. 2 shows that modulating a QC laser by direct modulation with a random sequence of digital input data produces irregular fluctuations in the optical output power. Due to the fluctuations, the optical output power of the QC laser may occasionally drop below threshold levels for transmitted data values and cause recognition errors in a distant receiver. For example, if the threshold for the output optical power associated with a modulated portion of the pumping voltage of 20 mV is level 36, then a receiver is likely to incorrectly identify the data value transmitted by the QC laser during the temporal interval 34.

The variations in the optical output power are more likely to generate errors when a transmitter modulates a QC laser by direct modulation at a high frequency and a high power level. For error-free direct modulation of a QC laser in an optical transmitter, optical output power variations must be controlled, i.e., at least for high data-rates and output powers.

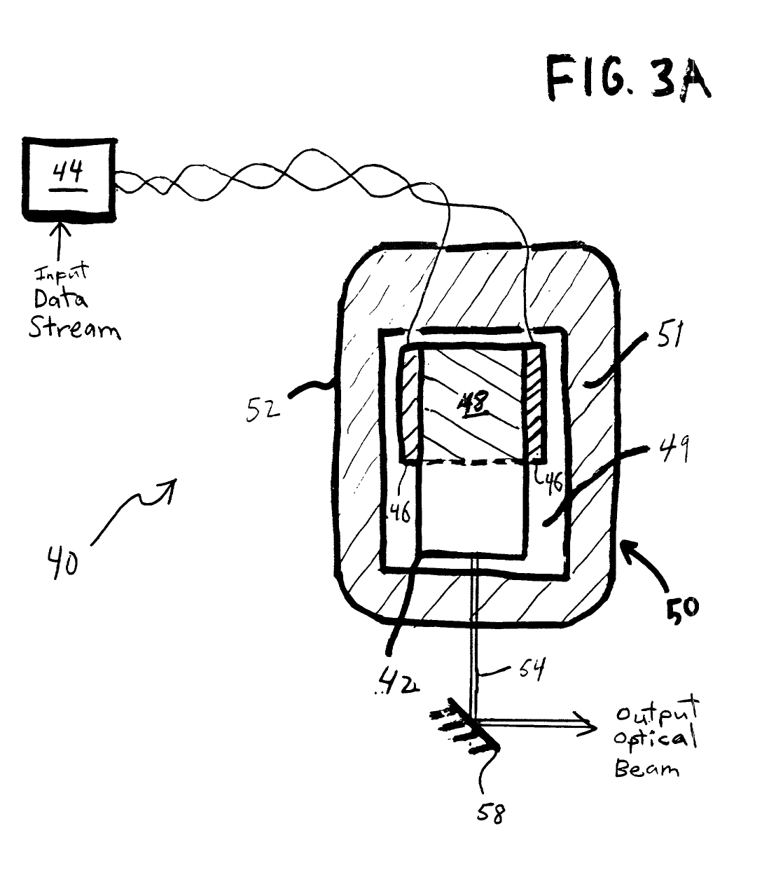

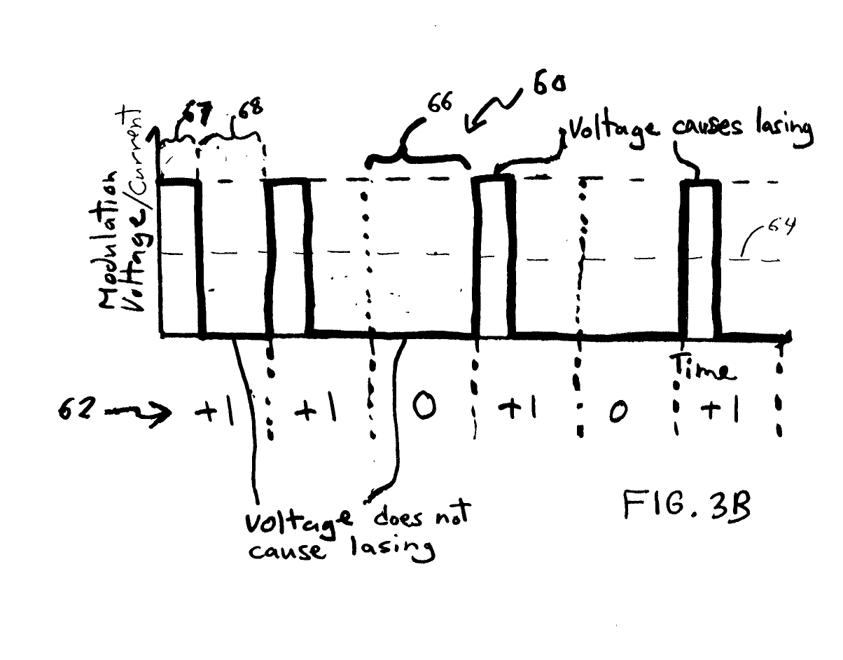

FIG. 3A shows one embodiment of an optical transmitter 40 that includes a QC laser 42 and an electrical modulator 44. Exemplary QC lasers 42 are described in U.S. Pat. No. 6,055,254, which is incorporated herein by reference in its entirety. The electrical modulator 44 modulates the QC laser 42 by direct modulation via a current signal. The signal is applied across electrodes 46 to electrically pump the laser's gain media 48.

The QC laser 42 also has a thermal contact with a cooling device 50. The cooling device 50 reduces temperature variations in the laser's gain media 48 during direct modulation. The cooling device 50 has a cooling power capable of dissipating heat produced during the modulation so that temperature variations of gain media 48 remain in a preselected range. In the preselected range, the temperature variations do not cause unacceptable variations in the optical output power of the QC laser 42.

The range of acceptable temperature variations depends on modulation frequency, data type, modulation current, and receiver sensitivity. The modulation frequency and data type dependencies have been illustrated in FIGS. 1A-1C and 2 and relate to dependencies on the data rate and on the average length and variance of the temporal periods in which the data causes lasing. The modulation current dependency relates to the dependence of power dissipation in gain media 48 on the amplitude of the modulation current. The receiver sensitivity dependency relates to the dependency on threshold optical powers that distinguish different data values. If temperature variations cause optical transmission power levels to wander between power ranges that the receiver recognizes as associated with different data values, the temperature variations will produce errors.

FIG. 3A shows one embodiment of cooling device 50 that includes a cold finger 49. The cold finger 49 forms a thermal contact between a coolant media 51 located in a container 52 and laser 42. Exemplary coolant media 51 include liquid nitrogen and liquid air. The cold finger 49 mediates the transfer of heat from the laser 42 to the coolant media 51 at a rate that is fast enough to keep temperature variations in gain media 48 and thus, optical output power variations of the laser 42 within the acceptable ranges.

In alternate embodiments, the cooling device 50 uses a thermo-electric cooling device, in thermal contact with laser 42 to provide cooling and maintain temperature variations of gain media 48 in the acceptable range. The construction and use of thermoelectric cooling devices is known to persons of skill in the art.

The QC laser 42 produces an amplitude modulated output beam 54. The output beam 54 is directed by passive optics 58 through free space to a receiver (not shown).

FIG. 3B shows a modulation voltage/current waveform 60 that is generated by an alternate embodiment of modulator 44 of FIG. 3A in response to a sequence 62 of binary input data values, i.e., 0 and 1. The data values of the sequence 62 have equal temporal durations. During time interval 66, the modulator 44 produces a pumping voltage/current that is below the lasing-threshold voltage 64 and associated with the data value 0. During a first portion 67 of a time interval associated with a data value 1, the modulator 44 produces a pumping voltage/current above the lasing-threshold voltage 64. During a remaining portion 68 of the time interval associated with the data value 1, the modulator 44 produces a pumping voltage/current below the lasing-threshold voltage 64. In exemplary modulators 44, the first portion is less than 70, 50, 40, 30, or 10 percent of the total time interval associated with one data value. Thus, these embodiments of modulator 44 cause lasing during intervals that are shorter than time intervals associated with the particular data values causing the lasing.

The modulation waveform 60 reduces total times in which laser 42 of FIG. 3A lases by restricting lengths of lasing intervals to be shorter than individual data intervals. Reducing the lengths of the lasing periods reduces heating in gain media 48, i.e., amounts of heat produced are related to time integrals of pumping powers. Thus, the modulation waveform 60 reduces temperature variations and optical output power variations in laser 42 during transmission of data sequences. Using a modulator 44 configured to generate modulation waveforms like the waveform 60 enables higher data rates and lowers the amount of cooling needed to maintain acceptable optical output characteristics. e.g., the cooling device 50 is unnecessary for some such modulation waveforms.

Cooling with cooling device 50 of FIG. 3A and modulating with pumping voltages/currents that have waveforms similar to waveform 60 of FIG. 3B provide temperature stabilization to QC laser 42 during direct modulation.

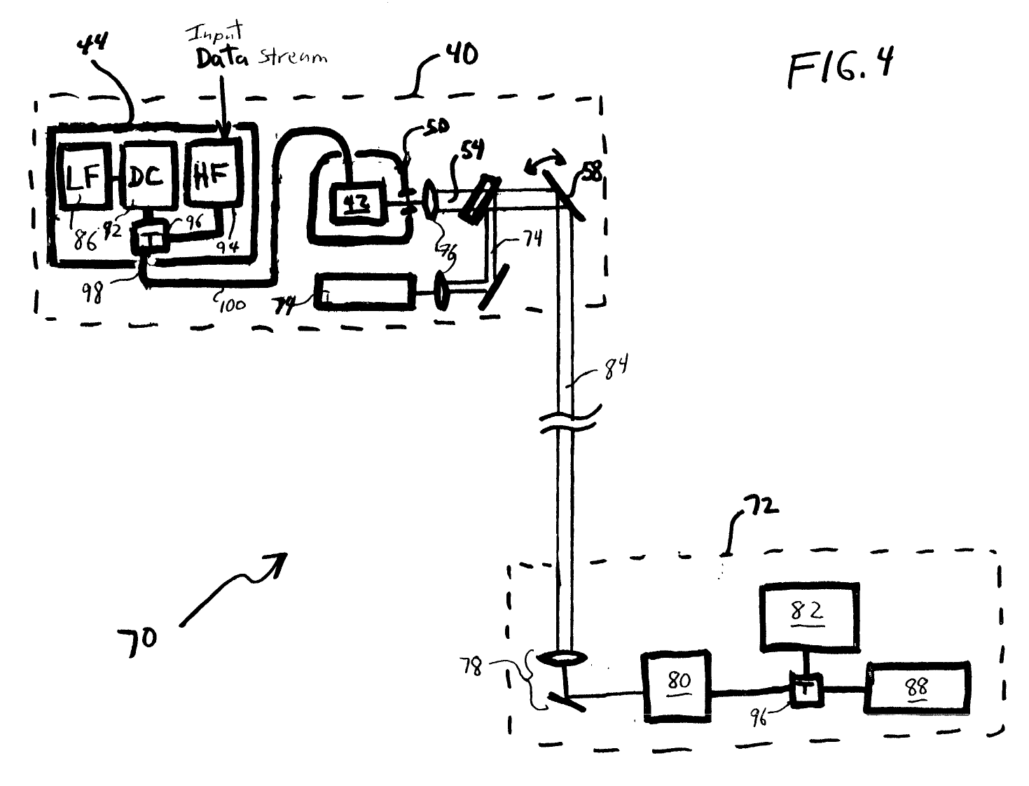

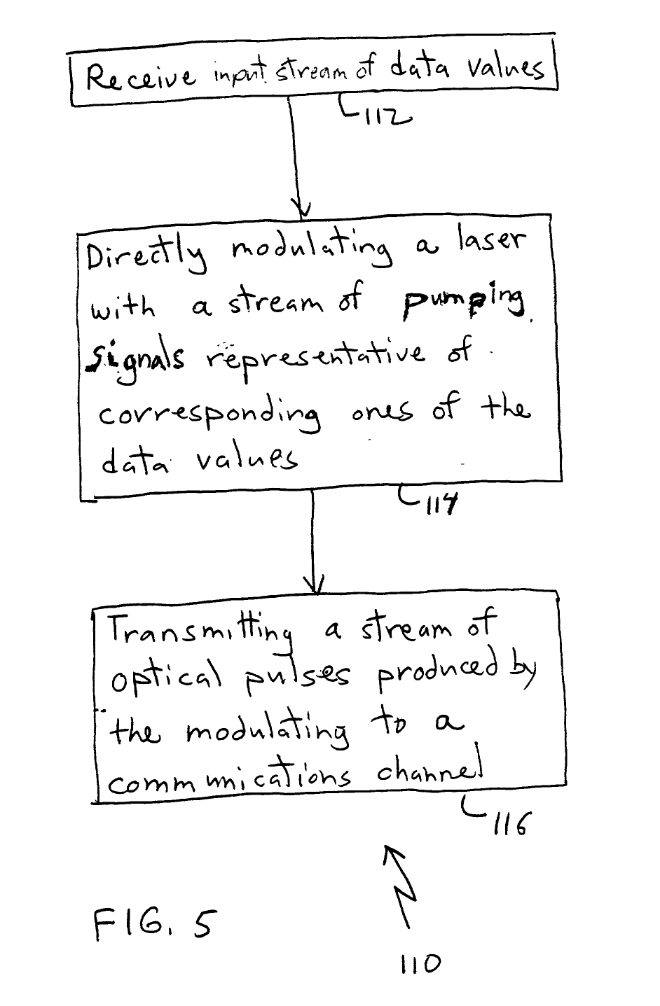

FIG. 4 shows an optical communication system 70, e.g., a last-mile optical communication system that provides FSODT in an urban area. The system 70 includes optical transmitter 40 of FIGS. 3A-3B and optical receiver 72. The optical transmitter 40 includes electrical modulator 44, QC laser 42, cooling device 50, beam expansion optics 76, targeting optics 58, and optionally a visible-light laser 74. The receiver 72 includes collection optics 78, an IR intensity detector 80 and received signal monitor 82. The monitor 82 electrically decodes and uses the data transmitted by the QC laser 42.

The communication system 70 includes optional devices that function during physical and electronic setup. During physical setup of optical transmitter 40, visible-light laser 74 produces a light beam that is visible and used to physically align targeting optics 58 so that output beam 84 is aimed towards collection optics 78 of the receiver 72. During electronic setup, a low-frequency (LF) source 86 modulates the pumping voltage/current from modulator 44, and a lock-in amplifier 88 in the receiver 72 detects modulations in the received signal at the frequency of the LF source 86. The LF modulation and phase-matched detection aid in setting electronic calibrations in the receiver 72.

The modulator 44 includes a direct current (DC) voltage source 92 and a high-frequency (HF) modulator 94 that electrically couple via a bias tee 96 to output terminal 98. The DC voltage source 92 supplies a constant pumping voltage that maintains the QC laser 42 in a non-lasing state near the lasing-threshold, e.g., about 0.1 volts to about 0.001 volts below the threshold. Maintaining the QC laser 42 near the threshold enables smaller AC voltages, e.g., 0.1 volts to 0.001 volts, to cause the QC laser 42 to switch between the lasing and non-lasing states during direct modulation. The high frequency (HF) modulator 94 produces an output voltage whose amplitude is responsive to input digital or analog data received by the transmitter 40. The output voltage from the HF modulator 94 is configured to increase the pumping voltage/current on the QC laser 42 to an above-lasing-threshold value in response to some types of input data, e.g., data values equal to logic +1. The bias tee 96 electrically isolates the DC voltage source 92 from signals on the line 100 connecting the modulator 44 and the QC laser 42.

FIG. 5 is a flow chart illustrating a process 110 for transmitting data by direct modulation of a QC laser, e.g., laser 42 of FIG. 4. The process 110 includes receiving a stream of input analog or digital data values in a modulator, e.g., modulator 44 of FIG. 4 (step 112). The modulator modulates the QC laser through direct modulation (step 114). The direct modulation involves pumping the laser with a stream of electrical or optical pumping signals whose forms are representative of corresponding ones of the input data values from the received stream. The QC laser transmits a stream of optical pulses caused by the direct modulation via a free-space channel to a remote receiver, e.g., receiver 72 (step 116).

The direct modulation includes modulated pumping of the laser's output power between high and low levels that the remote receiver identifies as transmitter-on and transmitter-off states, respectively. In some embodiments, the transmitter-on and transmitter-off states are lasing and non-lasing states of the QC laser. In other embodiments, the transmitter-on and transmitter-off states are respectively above and below the detection threshold of the receiver.

Referring again to FIG. 4, various embodiments of communication system 70 use an optical transmission band located in the mid-IR wavelength range to transmit data over free-space. Some embodiments take advantage of the availability of QC lasers with a wide range of output wavelengths and use a laser that generates light with a wavelength in a low atmospheric attenuation window. Transmitting data in such a window reduces the number of communication errors caused by atmospheric absorption and/or variable atmospheric conditions such as scattering.

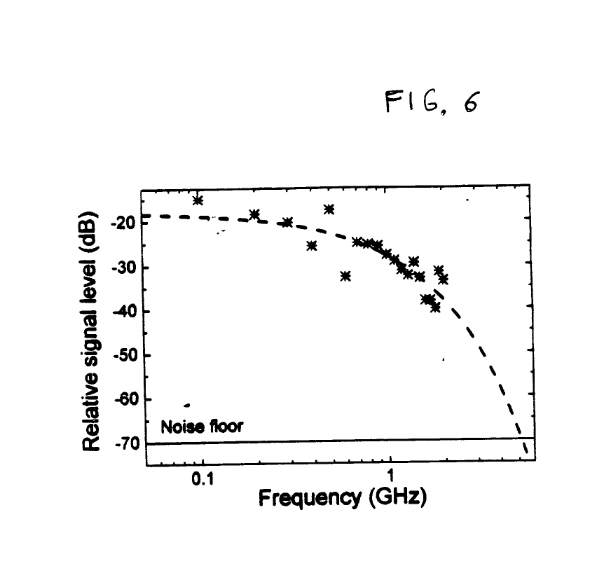

FIG. 6 shows how signal intensities depend on data frequency in free-space mid-IR transmission for one embodiment of the communication system 70 of FIG. 4. The noise floor represents the threshold for receiver 72 to identify transmitted digital data correctly and is provided in decibels (dB). The data points are represented by stars. The data points show that signal to noise levels decrease with increasing data frequency. Nevertheless, the data shows that direct modulation of an exemplary QC laser 42 is capable of transmitting digital data at a rate of 1 giga Hertz (GHz), 2 GHz, 4 GHz or higher.

Other embodiments of the invention will be apparent to those skilled in the art in light of the specification, drawings, and claims of this application.

What is claimed is:

1. A process for optically transmitting data to a remote receiver, comprising:
receiving a stream of input data signals;
modulating a mid-IR laser by direct modulation with a waveform whose sequential values are responsive to the data signals of the stream, the direct modulation including pumping the mid-IR laser to produce high and low optical power levels in response to different ones of the values; and
transmitting output light from the modulated mid-IR laser to the remote receiver via a free space communications channel.

2. The process of claim 1, wherein the remote receiver is configured to identify received light associated with the high optical power level and the low optical power as “signal-on” and “signal-off” states of the mid-IR laser, respectively.

3. The process of claim 2, wherein the modulating a mid-IR laser by direct modulation includes pumping a gain region of the laser with a modulation current whose successive values are responsive to the data signals of the stream.

4. The process of claim 1, wherein the modulating by direct modulation pumps the mid-IR laser to be in a lasing state during first intervals in response to input data signals having first signal values and to be in a non-lasing state during second intervals in response to input data signals having second signal values.

5. The process of claim 4, wherein the first intervals are shorter than the second intervals.

6. The process of claim 5, wherein the first and second signal values are first and second digital values, respectively.

7. The process of claim 2, wherein the modulating produces light of a wavelength between about 3.5 microns and about 24 microns.

8. The process of claim 1, wherein the wavelength of the produced light is at least as long as about 8 microns and not longer than about 13 microns.

9. The process of claim 1, wherein the wavelength of the produced light is at least as long as about 3.5 microns, not longer than about 5 microns, and not in a CO₂ absorption peak located at about 4.65 microns

10. The process of claim 1, wherein the modulating produces light in a spectral window in which atmospheric attenuation is lower than at adjacent wavelength ranges.

11. The process of claim 1, wherein the transmitting sends sequential modulated optical values at a rate that is at least as high as 1 giga-Hertz.

12. The process of claim 1, wherein the transmitting sends sequential modulated optical values at a rate that is at least as high as 2 giga-Hertz.

13. An optical transmitter, comprising:
a mid-IR laser having an optical gain media; and
a modulator connected to modulate pumping of the gain media during modulation intervals in a manner that is responsive to values of data signals received in associated data intervals, the modulator configured to cause the mid-IR laser to produce one optical power level in portions of ones of the modulation intervals associated with one value of the data signals and to produce relatively lower optical power levels in remainders of the ones of the modulation intervals associated with the one value of the data signal.

14. The transmitter of claim 13, wherein the modulator is configured to cause the mid-IR laser to lase in the portions of the intervals and to not lase in the remainders of the intervals.

15. The optical transmitter of claim 13, wherein the modulator applies a voltage across the gain media to modulate pumping of the media.

16. The transmitter of claim 13, wherein the mid-IR laser is a quantum cascade laser.

17. The transmitter of claim 13, wherein the mid-IR laser is configured to produce light with a wavelength of at least about 8 microns and not longer than about 13 microns.

18. The transmitter of claim 13, wherein the mid-IR laser is configured to produce light with a wavelength that is at least as long as about 3.5 microns, that is not longer than about 5 microns, and that is not in a CO₂ absorption peak located at about 4.65 microns

19. The transmitter of claim 13, wherein the mid-IR laser produces light in a spectral window in which atmospheric absorption is lower than at adjacent wavelength ranges.

20. The transmitter of claim 13, further comprising:
collimating optics positioned to collimate output light from the mid-IR laser into a beam with a diameter of at least 1 millimeter.

21. The optical transmitter of claim 13, wherein the modulator applies an optical pumping light to the gain media to modulate pumping of the gain media.

22. The optical transmitter of claim 13, wherein the modulator transmits an electrical current through the gain media to modulate pumping of the gain media.
